(19) United States
(12) Patent Application Publication
(10) Pub. No.: US 2024/0351544 A1
(43) Pub. Date: Oct. 24, 2024

(54) OCCUPANT DETECTION DEVICE AND IMAGE CAPTURING DEVICE

(71) Applicant: Mitsubishi Electric Corporation, Tokyo (JP)

(72) Inventors: Yuki SUSUMAGO, Tokyo (JP); Taro KUMAGAI, Tokyo (JP); Dongsuk PARK, Tokyo (JP); Kei KASUGA, Tokyo (JP)

(73) Assignee: Mitsubishi Electric Corporation, Tokyo (JP)

(21) Appl. No.: 18/682,851

(22) PCT Filed: Oct. 6, 2021
(86) PCT No.: PCT/JP2021/036939

§ 371 Date: Feb. 9, 2024

(51) Int. Cl. B60R 21/015; B60R 11/00; B60R 11/02; B60R 11/04

(52) U.S. Cl. CPC B60R 21/01538; B60R 11/0229; B60R 11/04; B60R 2011/0005

(57) ABSTRACT

A display unit mounted on a vehicle and provided in the vehicle and an image capturing unit detachably attached to the display unit to capture an image of an area in which at least a face of an occupant is to be present in the vehicle are provided.

### TECHNICAL FIELD

The present disclosure relates to an occupant detection device and an image capturing device for detecting a state of an occupant in a vehicle.

### BACKGROUND ART

Conventionally, there is known a technique of mounting an image capturing device on a vehicle and detecting an occupant on the basis of a captured image captured by the image capturing device. The image capturing device is preferably provided at a position where it is possible to accurately capture an image of the occupant in the vehicle, in other words, a position where it is possible to capture at least the face of the occupant in the vehicle. On the other hand, in most of the vehicles, a display device is provided at a position preferable as a disposing position of the image capturing device as described above so that the occupant can easily visually recognize the display device. Accordingly, in a vehicle, a technique of disposing the image capturing device at a position adjacent to the display device is known.

For example, Patent Literature 1 discloses an occupant image capturing device including a camera disposed on an instrument panel adjacent to a rear side of a display provided on the instrument panel in a vehicle front-rear direction outside the display, and capturing an image of a driver with the camera.

### CITATION LIST

### Patent Literatures

Patent Literature 1: JP 2019-14361 A

### SUMMARY OF INVENTION

### Technical Problem

In a conventional technique represented by the technique of the occupant image capturing device as disclosed in Patent Literature 1, a display device and an image capturing device are separated in the structure, and in the vehicle, each of the display device and the image capturing device is provided in a component of the vehicle such as an instrument panel. That is, the conventional technique has a problem that it is necessary to ensure a space for disposing the display device and a space for disposing the image capturing device in the vehicle.

The present disclosure has been made to solve the above problem, and an object thereof is to provide an occupant detection device in which an image capturing device is provided at a position preferable as a disposing position without requiring each of a space for disposing a display device and a space for disposing the image capturing device in a vehicle.

### Solution to Problem

An occupant detection device according to the present disclosure is to be mounted on a vehicle. The occupant detection device includes: a display unit to be provided in the vehicle; and an image capturing unit detachably attached to the display unit to capture an image of an area in which at least a face of an occupant is to be present in the vehicle.

### Advantageous Effects of Invention

According to the present disclosure, an image capturing device can be provided at a position preferable as a disposing position without requiring each of a space for disposing a display device and a space for disposing an image capturing device in a vehicle.

### BRIEF DESCRIPTION OF DRAWINGS

FIG. 1 is a diagram for describing a disposing example of an occupant detection device according to a first embodiment in a vehicle.

FIG. 2 is a diagram for describing an outline of the occupant detection device according to the first embodiment.

FIG. 3 is a diagram for describing an example of attachment of each of image capturing units having different specifications to a display unit in the occupant detection device according to the first embodiment.

FIGS. 4A and 4B are diagrams each describing an example of a display area of the image capturing unit and notification information displayed in the display area in the occupant detection device according to the first embodiment.

FIG. 5 is a diagram for describing an example of the occupant detection device to which a frame is attached in the first embodiment, in which FIG. 5A is a perspective view of the occupant detection device in a state where the occupant detection device is mounted on the vehicle as viewed from a front side, and FIG. 5B is a perspective view of the occupant detection device in a state where the occupant detection device is mounted on the vehicle as viewed from a back side.

FIG. 6 is a diagram for describing an example of attachment of the image capturing unit to the display unit in the occupant detection device according to the first embodiment, in which FIG. 6A is a diagram illustrating an example in which the image capturing unit is attached from a top face side of the display unit, FIG. 6B is a diagram illustrating an example in which the image capturing unit is attached from a right side face side of the display unit, FIG. 6C is a diagram illustrating an example in which the image capturing unit is attached from a left side face side of the display unit, and FIG. 6D is a diagram illustrating an example in which the image capturing unit is attached from a bottom face side of the display unit.

### DESCRIPTION OF EMBODIMENTS

Hereinafter, an embodiment of the present disclosure will be described in detail with reference to the drawings.

### First Embodiment

An occupant detection device according to a first embodiment is mounted on a vehicle, and is used to monitor a state of an occupant in what is called a “Driver Monitoring System (DMS)”. The occupant whose state is to be monitored (hereinafter referred to as an “occupant to be monitored”) in the driver monitoring system includes a driver in the driver's seat, an occupant in a passenger seat (hereinafter referred to as “passenger seat occupant”), or an occupant in a rear seat (hereinafter referred to as a “rear seat occupant”).

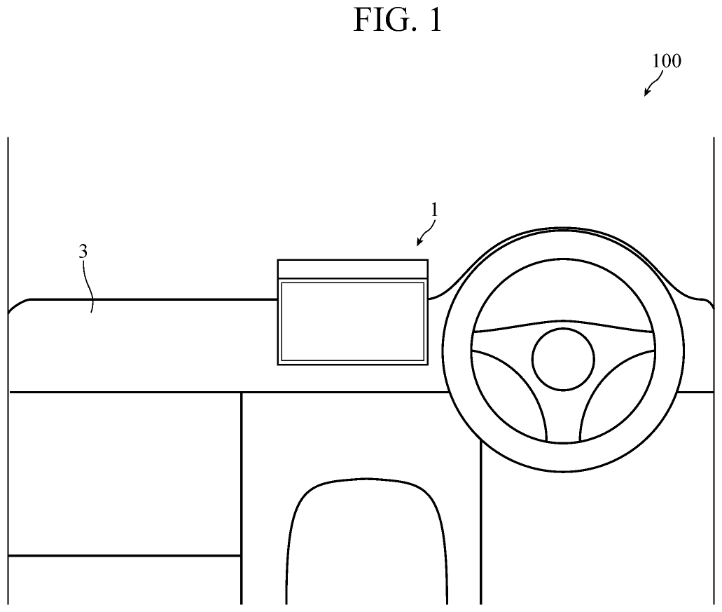

FIG. 1 is a diagram for describing a disposing example of an occupant detection device 1 according to the first embodiment in the vehicle.

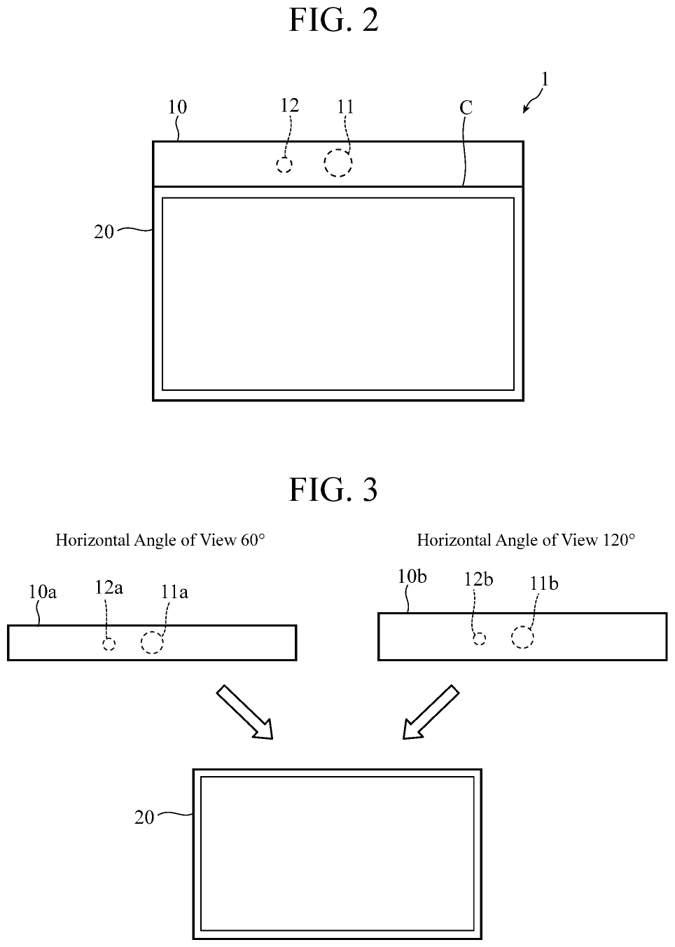

FIG. 2 is a diagram for describing an outline of the occupant detection device 1 according to the first embodiment.

FIG. 1 is a front view of an entire instrument panel (hereinafter referred to as an “instrument panel”) 3 as viewed from the inside of a vehicle 100. Note that, although the vehicle 100 illustrated in FIG. 1 is a right-hand drive vehicle, this is merely an example. The vehicle 100 may be a left-hand drive vehicle.

In FIG. 1, the outline of the occupant detection device 1 is not illustrated for simplicity of description. The outline of the occupant detection device 1 will be described later with reference to FIG. 2.

As illustrated in FIG. 1, an instrument panel 3 extending in a vehicle width direction below a windshield (not illustrated) is provided in a front part of the cabin. The occupant detection device 1 is provided at a center of the instrument panel 3 in the vehicle width direction. Note that, in the first embodiment, the center in the vehicle width direction is not necessarily strictly the center, but includes a substantially center. The occupant detection device 1 is erected, for example, at the center of the instrument panel 3 in the vehicle width direction.

For example, when the occupant to be monitored is the driver and the passenger seat occupant, normally, the position of the occupant detection device 1 as illustrated in FIG. 1 is assumed to be a preferable position as a disposing position of the occupant detection device 1 in the vehicle 100. This is because a display unit 20 (see FIG. 2) is at a position where it is easy for the driver and the passenger seat occupant to visually recognize, and an image capturing unit 10 (see FIG. 2) is at a position where it is easy to image both the face of the driver and the face of the passenger seat occupant.

As illustrated in FIG. 2, the occupant detection device 1 includes the image capturing unit 10 and the display unit 20. Note that the image capturing unit 10 alone functions as an image capturing device. The display unit 20 alone functions as a display device. A part indicated by C in FIG. 2 will be described later.

FIG. 2 is a front view of the occupant detection device 1. That is, FIG. 2 illustrates front faces of the image capturing unit 10 and the display unit 20.

The image capturing unit 10 has a front face, a back face, a top face, a bottom face, a right side face, and a left side face. In the first embodiment, the front face of the image capturing unit 10 is one face on the side where the face of the occupant is to be present in a state where the image capturing unit 10 is provided in the vehicle 100. The back face of the image capturing unit 10 is a face opposite to the front face of the image capturing unit 10, that is, one face opposite to the side where the face of the occupant is to be present in a state where the image capturing unit 10 is provided in the vehicle 100. The top face of the image capturing unit 10 is the top face in a state where the image capturing unit 10 is provided in the vehicle 100. The bottom face of the image capturing unit 10 is a face opposite to the top face of the image capturing unit 10, that is, the bottom face in a state where the image capturing unit 10 is provided in the vehicle 100. The right side face of the image capturing unit 10 is a right side face of the image capturing unit 10 as viewed from the cabin in a state where the image capturing unit 10 is provided in the vehicle 100. The left side face of the image capturing unit 10 is a left side face of the image capturing unit 10 as viewed from the cabin in a state where the image capturing unit 10 is provided in the vehicle 100.

The display unit 20 has a front face, a back face, a top face, a bottom face, a right side face, and a left side face. In the first embodiment, the front face of the display unit 20 is one face on the side where the face of the occupant is to be present in a state where the display unit 20 is provided in the vehicle 100. The back face of the display unit 20 is a face opposite to the front face of the display unit 20, that is, one face opposite to the side where the face of the occupant is to be present in a state where the display unit 20 is provided in the vehicle 100. The top face of the display unit 20 is the top face in a state where the display unit 20 is provided in the vehicle 100. The bottom face of the display unit 20 is a face opposite to the top face of the display unit 20, that is, the bottom face in a state where the display unit 20 is provided in the vehicle 100. The right side face of the display unit 20 is a right side face of the display unit 20 as viewed from the cabin in a state where the display unit 20 is provided in the vehicle 100. The left side face of the display unit 20 is a left side face of the display unit 20 as viewed from the cabin in a state where the display unit 20 is provided in the vehicle 100.

The image capturing unit 10 captures an image of an area in which the face of the occupant is to be present in the vehicle 100.

More specifically, the image capturing unit 10 includes a camera lens 11 and an illumination unit 12, and the illumination unit 12 irradiates a subject, in other words, an occupant with light and performs imaging through the camera lens 11. The illumination unit 12 is constituted by, for example, a light emitting diode (LED). The illumination unit 12 is provided to illuminate the inside of the vehicle 100 in which the image capturing unit 10 is provided.

The captured image captured by the image capturing unit 10 is output to a control unit (not illustrated). The control unit is provided in the image capturing unit 10, for example, and detects the state of an occupant captured in the captured image on the basis of the captured image captured by the image capturing unit 10. Specifically, the control unit detects whether or not the occupant is in a distracted driving state, whether or not the occupant is in a dozing state, or the like. Note that the control unit may detect the state of the occupant by detecting the state of the face of the occupant such as a face orientation, the line of sight, or the degree of opening and closing of the eyes using known image recognition techniques. Note that the control unit is not necessarily included in the image capturing unit 10. For example, the control unit may be included in the display unit 20 or may be included in a server (not illustrated) included in the driver monitoring system.

The display unit 20 includes, for example, a touch panel display provided with a touch screen on the front face of a flat display such as a liquid crystal display or an organic EL display.

The display unit 20 displays various types of information. For example, the display unit 20 displays information based on the state of the occupant detected by the control unit. The information based on the state of the occupant is, for example, a message for warning that the occupant is in a distracted driving state or a message for warning that the occupant is in a dozing state. In addition, the display unit 20 may display various types of information such as map information, route information, or audio information. The display unit 20 may be shared with, for example, a car navigation device (not illustrated).

Note that, in FIG. 1, the occupant detection device 1 is erected at the center of the instrument panel 3 in the vehicle width direction, but this is merely an example. For example, the occupant detection device 1 may be fitted into an opening formed at the center of the instrument panel 3 in the vehicle width direction and on a rear side face of the instrument panel 3 in the front-rear direction of the vehicle 100.

Further, the location of the occupant detection device 1 in the vehicle 100 is not limited to the center of the instrument panel 3 in the vehicle width direction.

The occupant detection device 1 may be provided, for example, in a meter panel (not illustrated). For example, there is a case where the occupant to be detected is limited to the driver. In this case, by providing the occupant detection device 1 in the meter panel, the occupant detection device 1, more specifically, the image capturing unit 10 and the display unit 20 are located substantially in front of the driver, where the image capturing unit 10 easily captures an image of the face of the driver and the display unit 20 is easily visually recognized by the driver. That is, the image capturing unit 10 and the display unit 20 are provided at preferable positions.

In addition, the occupant detection device 1 may be provided above a headrest (not illustrated), such as an overhead console (not illustrated).

For example, there is a case where the occupant to be detected includes the driver, the passenger seat occupant, and an occupant in a rear seat. In this case, by providing the occupant detection device 1 above the headrest, the occupant detection device 1, more specifically, the image capturing unit 10 and the display unit 20 are located at positions where the image capturing unit 10 easily captures an image of the faces of the driver, the passenger seat occupant, and the occupant in the rear seat, and the display unit 20 is easily visually recognized by the driver, the passenger seat occupant, and the occupant in the rear seat. That is, the image capturing unit 10 and the display unit 20 are provided at preferable positions.

In addition, the occupant detection device 1 may be provided, for example, on a dashboard (not illustrated).

For example, the occupant to be detected may be limited to the passenger seat occupant. In this case, since the occupant detection device 1, more specifically, the image capturing unit 10 and the display unit 20 are provided on the dashboard, the occupant detection device 1, more specifically, the image capturing unit 10 and the display unit 20 are located substantially in front of the passenger seat occupant where the image capturing unit 10 easily captures an image of the face of the passenger seat occupant and the display unit 20 is easily visually recognized by the passenger seat occupant. That is, the image capturing unit 10 and the display unit 20 are provided at preferable positions.

The image capturing unit 10 is physically separate from the display unit 20, and is detachably attached to the display unit 20.

Note that the occupant detection device 1 illustrated in FIGS. 1 and 2 is in a state where the image capturing unit 10 is attached to the display unit 20, in other words, in a state where the image capturing unit 10 and the display unit 20 are connected. The occupant detection device 1 has an integrated configuration in which the image capturing unit 10 is attached to the display unit 20.

The occupant detection device 1 is mounted on the vehicle 100 in a state where the image capturing unit 10 is attached to the display unit 20. For example, the image capturing unit 10 is attached to the display unit 20 and then mounted on the vehicle 100, so that the display unit 20 and the image capturing unit 10, in other words, the occupant detection device 1 is provided in the vehicle 100. In addition, for example, by providing the display unit 20 in the vehicle 100, and then attaching the image capturing unit 10 to the display unit 20 provided in the vehicle 100, the display unit 20 and the image capturing unit 10, in other words, the occupant detection device 1 may be provided in the vehicle.

The occupant detection device 1 solves a problem that, by attaching the image capturing unit 10 to the display unit 20 to have an integral configuration, the display unit 20 is provided at a preferable position as a disposing position for the image capturing unit 10, and the image capturing unit 10 and the display unit 20 are provided at positions preferable as disposing positions for both the image capturing unit 10 and the display unit 20.

Then, in order to mount the occupant detection device 1 on the vehicle 100, it is not necessary to ensure a space for disposing the display unit 20 and a space for disposing the image capturing unit 10 in the vehicle 100. For example, in the occupant detection device 1 illustrated in FIG. 1, it is sufficient for the instrument panel 3 of the vehicle 100 to ensure a space for disposing the display unit 20.

Here, even if the occupant detection device 1 has an integral configuration in which the image capturing unit 10 and the display unit 20 are undetachable, it is possible to solve the problem that it is necessary to ensure a space for disposing the display unit 20 and a space for disposing the image capturing unit 10 in the vehicle 100.

However, when the occupant detection device 1 has a simple integral configuration in which the image capturing unit 10 and the display unit 20 are undetachable, there arises a problem that the image capturing unit 10 may not be able to capture a captured image optimal for occupant state detection.

In general, the display unit 20 is provided at a position assumed to be preferable as a disposing position in the vehicle 100, and the preferable position varies depending on, for example, specifications of the vehicle 100. In the first embodiment, the specifications of the vehicle 100 are assume to be, for example, a vehicle type, a grade of the vehicle 100, or an orientation of the display unit 20 in a state where the display unit 20 is provided in the vehicle 100.

As a specific example, in a case where the occupant to be detected is the driver and the passenger seat occupant, for example, an optimum position as the disposing position of the display unit 20 in the vehicle 100 is normally assumed to be the center of the instrument panel 3 in the vehicle width direction. However, depending on the vehicle type, the optimum position may be located significantly closer to the driver's seat side or the passenger seat side than the center due to restrictions such as the design of the instrument panel 3.

If the image capturing unit 10 attached to the display unit 20 to be installed at the center in the vehicle width direction of the instrument panel 3 and the image capturing unit 10 attached to the display unit 20 to be installed on the dashboard are assumed to have the same imaging area, the driver or the passenger seat occupant who is the occupant to be detected may not be captured in a captured image captured by either of the image capturing units 10. For example, an event that a part of the face of the occupant to be detected is out of view in the captured image or the eyes of the occupant to be detected are not recognized, or the like may occur. Therefore, in this case, for example, a manufacturer or the like needs to manufacture, depending on the vehicle type, the occupant detection device 1 in which the image capturing unit 10 configured to be able to image the driver and the passenger seat occupant from the center of the instrument panel 3 in the vehicle width direction when mounted on the vehicle 100 and the display unit 20 installed on the instrument panel 3 are integrated, and the occupant detection device 1 in which the image capturing unit 10 configured to be able to image the driver and the passenger seat occupant from the dashboard when mounted on the vehicle 100 and the display unit 20 mounted on the dashboard are integrated. Note that the manufacturer or the like can use the display unit 20 that is common to these occupant detection devices 1.

In addition, for example, even in the same vehicle type, the occupants to be detected may be switched to the driver and the passenger seat occupant or to the driver only depending on the grade of the vehicle 100.

In this case, even in the vehicles 100 of the same vehicle type, the imaging area required for the image capturing unit 10 attached to the display unit 20 is different depending on the grade. For example, if the grade of the vehicle 100 is a grade in which the occupant to be detected is the driver and the passenger seat occupant, a preferable position as the disposing position of the occupant detection device 1, more specifically, the image capturing unit 10 and the display unit 20 is the center in the vehicle width direction, and the image capturing unit 10 needs to include the driver and the passenger seat occupant who are the occupants to be detected in the imaging area from the center. On the other hand, for example, if the grade of the vehicle 100 is a grade that limits the occupant to be detected to the driver, the preferable position as the disposing position of the occupant detection device 1 is a position facing the driver, such as a meter panel, and the image capturing unit 10 only needs to be able to include the driver in the imaging area from the position.

Therefore, the manufacturer or the like needs to manufacture the occupant detection device 1 in which the display unit 20 and the image capturing unit 10 having the required imaging area, in other words, the required angle of view are integrated depending on the grade of the vehicle 100. Note that the manufacturer or the like can use the display unit 20 that is common to these occupant detection devices 1.

Further, in general, for the display unit 20, in addition to a position assumed to be preferable as a disposing position in the vehicle 100, a disposing angle preferable in the vehicle 100 is also different depending on the specifications of the vehicle 100.

As a specific example, for example, depending on the vehicle type, the height of the disposing position that is regarded as an optimum position of the display unit 20 in the vehicle 100 with respect to the area in which the face of the occupant is to be present may be different due to restrictions such as the design of the instrument panel 3.

In this case, when the orientation of the image capturing unit 10 attached to the display unit 20 is uniform regardless of the height of the display unit 20 to which the image capturing unit 10 is attached with respect to the area in which the face of the occupant is to be present, the occupant to be detected may not be captured in the captured image captured by the image capturing unit 10. Therefore, in this case, the manufacturer or the like needs to manufacture the occupant detection device 1 in which the display unit 20 and the image capturing unit 10 in which the optical axis is set in consideration of the height of the display unit 20 with respect to the area in which the face of the occupant is to be present are integrated depending on the vehicle type. The manufacturer or the like also needs to set the irradiation area of the illumination unit 12 in consideration of the disposing angle when the display unit 20 is installed in the vehicle 100. Note that the manufacturer or the like can use the display unit 20 that is common to these occupant detection devices 1.

Further, for example, the optimum disposing angle of the display unit 20 may be different depending on the vehicle type.

In this case, when the orientation of the image capturing unit 10 attached to the display unit 20 is uniform regardless of the disposing angle of the display unit 20 to which the image capturing unit 10 is attached, the occupant to be detected may not be captured in the captured image captured by the image capturing unit 10. Therefore, in this case, the manufacturer or the like needs to manufacture the occupant detection device 1 in which the display unit 20 and the image capturing unit 10 in which the optical axis is set in consideration of the disposing angle when the display unit 20 is installed in the vehicle 100 are integrated depending on the vehicle type. The manufacturer or the like also needs to set the irradiation area of the illumination unit 12 in consideration of the disposing angle when the display unit 20 is installed in the vehicle 100. Note that the manufacturer or the like can use the display unit 20 that is common to these occupant detection devices 1.

If the occupant detection devices 1 are devices in which the image capturing unit 10 and the display unit 20 are simply integrated, as in the above specific examples, there arises a problem that, although the display unit 20 can be common, the manufacturer or the like needs to design or manufacture each occupant detection device 1 so that the image capturing unit 10 in a state where the occupant detection device 1 is mounted on the vehicle 100 is the required image capturing unit 10 in accordance with the specifications of the vehicle 100. That is, the number of types of occupant detection devices 1 including the display unit 20 increases, and a manufacturer or the like requires more labor or the like to design or manufacture the occupant detection devices 1.

On the other hand, in the occupant detection device 1 according to the first embodiment, as described above, the image capturing unit 10 is detachably attached to the display unit 20.

Thus, the manufacturer or the like can provide the occupant detection devices 1 by manufacturing the image capturing units 10 in accordance with the specifications of the vehicle 100 and by freely combining the common display unit 20 thereto. The display unit 20 can be shared regardless of the specifications of the vehicle 100, and thus the manufacturer or the like can suppress labor or the like required for designing or manufacturing the occupant detection devices 1.

In the occupant detection device 1 according to the first embodiment, the image capturing unit 10 is attached to the display unit 20 by appropriate means. For example, the image capturing unit 10 and the display unit 20 may be attached by being screwed on the back face side of the display unit 20, or may be connected to each other by a plug and a jack.

FIG. 3 is a diagram for describing an example of attachment of the image capturing units 10 having different specifications to the display unit 20 in the occupant detection device 1 according to the first embodiment. Note that, in the first embodiment, the specifications of the image capturing unit 10 are assumed to be the imaging area of the image capturing unit 10, in other words, the angle of view, the direction of the optical axis of the image capturing unit 10, the presence or absence of the display area, the type of information to be displayed in the display area, and the like. Details of the display area that the image capturing unit 10 can have will be described later.

FIG. 3 is a diagram describing, as an example, attachment of two image capturing units 10 (an image capturing unit 10a or an image capturing unit 10b) having different angles of view to the display unit 20.

The image capturing unit 10a includes a camera lens 11aand an illumination unit 12a, irradiates a subject with light by the illumination unit 12a, and performs imaging through the camera lens 1a. The angle of view of the image capturing unit 10a is horizontal 60°. The image capturing unit 10a is assumed to be the image capturing unit 10 included in the occupant detection device 1, for example, in a case where the occupant to be detected is limited to a driver.

The image capturing unit 10b includes a camera lens 11b and an illumination unit 12b, irradiates a subject with light by the illumination unit 12b, and performs image-capturing through the camera lens 11b. The angle of view of the image capturing unit 10b is horizontal 120°. For example, in a case where the occupant to be detected is a driver and a passenger seat occupant, the image capturing unit 10b assumes the image capturing unit 10 included in the occupant detection device 1.

Note that FIG. 3 illustrates an example in which the image capturing units 10 (the image capturing unit 10a or the image capturing unit 10b) having different angles of view can each be attached to the display unit 20, but this is merely an example.

For example, the image capturing units 10 whose directions of the optical axis are different can each be attached to the display unit 20.

As described above, the occupant detection device 1 according to the first embodiment has an integrated configuration in which the image capturing unit 10 attachable to and detachable from the display unit 20 and corresponding to the specifications of the vehicle 100 on which it is mounted is attached to the display unit 20.

Here, the front face of the image capturing unit 10 is covered with a panel (hereinafter referred to as a “first panel”). The front face of the display unit 20 is covered with a panel (hereinafter referred to as a “second panel”). The first panel and the second panel are made of the same material. The material of the first panel and the second panel is, for example, polycarbonate or glass.

In the occupant detection device 1, since the first panel and the second panel are made of the same material, the occupant detection device 1 can create a unity of appearance between the image capturing unit 10 and the display unit 20.

Further, in the occupant detection device 1, in a state where the image capturing unit 10 is attached to the display unit 20, a distance (see C of FIG. 2) between one side of the image capturing unit 10 on a side attached to the display unit 20 and one side of the display unit 20 on a side to which the image capturing unit 10 is attached is equal to or less than a set distance. The set distance only needs to be a distance that does not impair the unity of appearance between the image capturing unit 10 and the display unit 20, for example, about 1 mm or less. Thus, the occupant detection device 1 can create the unity of appearance between the image capturing unit 10 and the display unit 20.

In addition, in the occupant detection device 1, the image capturing unit 10 may have a display area on the front face. In the display area of the image capturing unit 10, information (hereinafter referred to as “notification information”) to alert occupants is displayed.

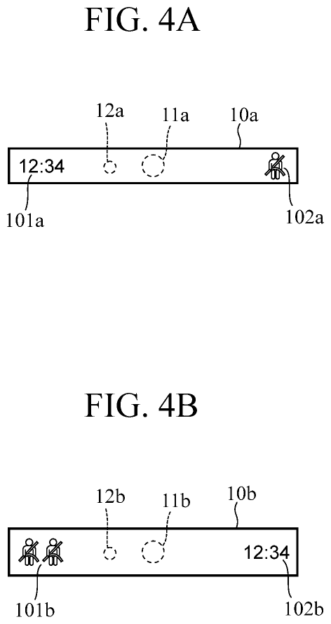

FIGS. 4A and 4B are diagrams for describing an example of display areas 101a, 102a, 101b, and 102b of the image capturing unit 10 and notification information displayed in the display areas in the occupant detection device 1 according to the first embodiment.

Note that the image capturing unit 10a illustrated in FIG. 4A is assumed to be the image capturing unit 10a illustrated in FIG. 3, and the image capturing unit 10b illustrated in FIG. 4B is assumed to be the image capturing unit 10b illustrated in FIG. 3.

The image capturing unit 10a illustrated in FIG. 4A has, for example, the display area 101a for displaying a clock and the display area 102a for displaying a telltale. In FIG. 4A, a seat belt warning light is displayed as the telltale. For example, the image capturing unit 10a is assumed to be the image capturing unit 10 in a case where the occupant whose state is to be detected using the occupant detection device 1 is limited to the driver, and thus the seat belt warning light is a telltale prompting the driver to wear the seat belt.

The image capturing unit 10b illustrated in FIG. 4B has, for example, the display area 101b for displaying a telltale and the display area 102b for displaying a clock. In FIG. 4B, a seat belt warning light is displayed as the telltale. For example, the image capturing unit 10b is assumed to be the image capturing unit 10 in a case where the occupant whose state is to be detected using the occupant detection device 1 is the driver and the passenger seat occupant, and thus the seat belt warning light is a telltale prompting the driver or the passenger seat occupant to wear the seat belt.

Note that, it is assumed that the image capturing unit 10a illustrated in FIG. 4A and the image capturing unit 10b illustrated in FIG. 4B each have two display areas, but this is merely an example. The image capturing unit 10 may have one display area or three or more display areas. In addition, the content of the notification information displayed in the display area of the image capturing unit 10 can be set as appropriate.

For example, the control unit may control the display of the notification information in the display area included in the image capturing unit 10.

Since the image capturing unit 10 has the display area and can display the notification information in the display area, it is possible to cause the occupant to recognize indispensable display.

When the occupant detection device 1 is mounted on the vehicle 100, the image capturing unit 10 is provided at a position facing the occupant to be detected, in other words, a preferable position as a disposing position of the image capturing unit 10 by being attached to the display unit 20. That is, the image capturing unit 10 is provided at a position where the face of the occupant can be optimally imaged. It can be said that the image capturing unit 10 is provided at a position facing the occupant where the occupant easily faces when viewed from the occupant. The display area is located at a position where the occupant can easily visually recognize, and the occupant can easily recognize the notification information.

In addition, the occupant detection device 1 according to the first embodiment can include, for example, a frame that covers the entire side faces of the display unit 20 and the image capturing unit 10 in a state where the image capturing unit 10 is attached to the display unit 20. Specifically, the occupant detection device 1 can include a frame that covers both side faces of each of the display unit 20 and the image capturing unit 10, the bottom face of the display unit 20, and the top face of the image capturing unit 10 in the entire side faces of the display unit 20 and the image capturing unit 10 in a state where the image capturing unit 10 is attached to the display unit 20.

In addition, for example, the occupant detection device 1 may include a frame that covers a portion other than the bottom face in the entire side faces of the display unit 20 and the image capturing unit 10 in a state where the image capturing unit 10 is attached to the display unit 20. Specifically, the occupant detection device 1 may include a frame that covers the both side faces of each of the display unit 20 and the image capturing unit 10 and the top face of the image capturing unit 10 in the entire side faces of the display unit 20 and the image capturing unit 10 in a state where the image capturing unit 10 is attached to the display unit 20.

The frame can be made of appropriate material. The thickness of the frame is smaller than the thicknesses of the image capturing unit 10 and the display unit 20. This enables the occupant detection device 1 to make the connected image capturing unit 10 and display unit 20 appear thinner to the occupant or the like.

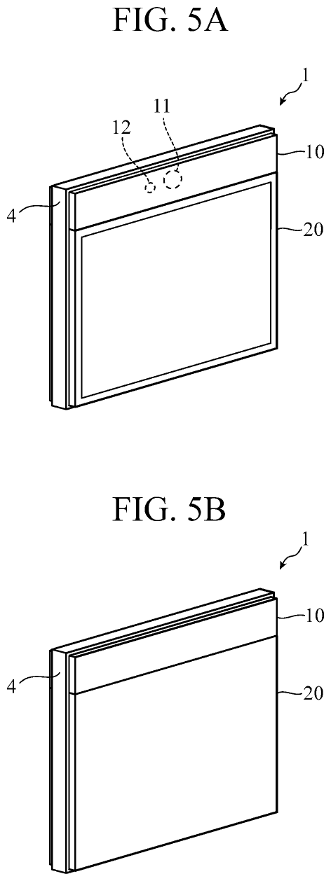

FIG. 5 is a diagram for describing an example of the occupant detection device 1 to which a frame 4 is attached in the first embodiment.

FIG. 5A is a perspective view of the occupant detection device 1 as viewed from the front side, and FIG. 5B is a perspective view of the occupant detection device 1 as viewed from the back side.

In FIG. 5, the frame 4 covers the entire side faces of the display unit 20 and the image capturing unit 10 in a state where the image capturing unit 10 is attached to the display unit 20. More specifically, in FIG. 5, the frame 4 covers the left side face, the top face, and the right side face of the image capturing unit 10 and the right side face, the bottom face, and the left side face of the display unit 20 in a state where the image capturing unit 10 is connected to the top face of the display unit 20.

Note that the thickness of the image capturing unit 10 and the thickness of the display unit 20 are not necessarily the same. In addition, in the occupant detection device 1, the image capturing unit 10 and the display unit 20 are connected, and the first panel of the image capturing unit 10 and the second panel of the display unit 20 have the same plane.

Note that, in the first embodiment described above, in the occupant detection device 1, it is based on the premise that the image capturing unit 10 is attached to the display unit 20 from a top face side of the display unit 20 provided in the vehicle 100, but this is merely an example. In the occupant detection device 1, the image capturing unit 10 is attached to the display unit 20, which is provided in the vehicle 100, from the top face side of the display unit 20, a left side face side of the display unit 20, a right side face side of the display unit 20, or a bottom face side of the display unit 20. Thus, the occupant detection device 1 can cause the position of the image capturing unit 10 with respect to the display unit 20 to be a position at which an optimum captured image can be obtained in accordance with the specifications of the vehicle 100 on which the occupant detection device 1 is mounted.

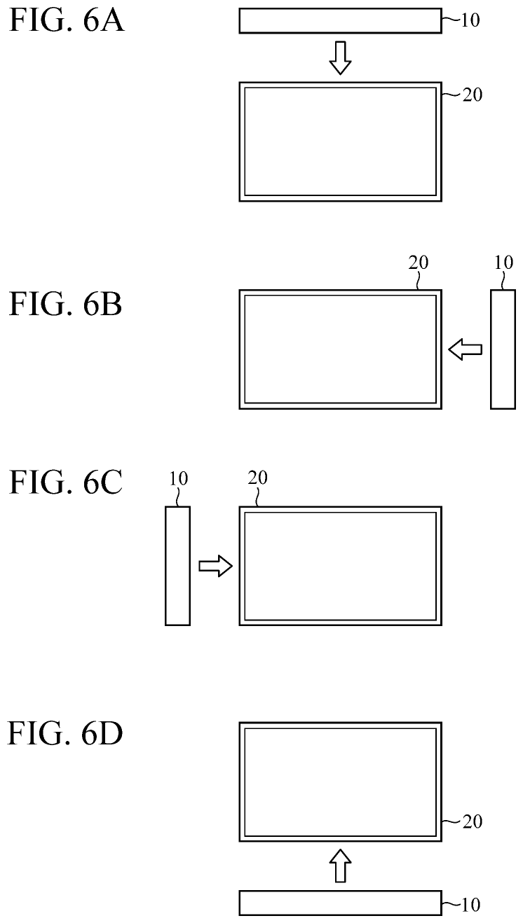

FIG. 6 is a diagram for describing examples of attachment of the image capturing unit 10 to the display unit 20 in the occupant detection device 1 according to the first embodiment.

FIG. 6A is a diagram illustrating an example in which the image capturing unit 10 is attached from the top face side of the display unit 20, FIG. 6B is a diagram illustrating an example in which the image capturing unit 10 is attached from the right side face side of the display unit 20, FIG. 6C is a diagram illustrating an example in which the image capturing unit 10 is attached from the left side face side of the display unit 20, and FIG. 6D is a diagram illustrating an example in which the image capturing unit 10 is attached from the bottom face side of the display unit 20.

Note that the occupant detection device 1 illustrated in FIG. 6 is assumed to be viewed from the front.

Note that, as illustrated in FIG. 6D, in a case where the image capturing unit 10 is attached to the display unit 20 from the bottom face side of the display unit 20, the occupant detection device 1 is mounted on the vehicle 100 in a state where the image capturing unit 10 is integrally attached to the display unit 20 from the bottom face side. Alternatively, the image capturing unit 10 may be provided in the vehicle 100 first, and the occupant detection device 1 may be integrated by attaching the display unit 20 to the image capturing unit 10 provided in the vehicle 100.

For example, when the vehicle 100 is a right-hand drive vehicle as illustrated in FIG. 1, there is a possibility that the image capturing unit 10 (see FIG. 6B) attached from the right side face side of the display unit 20 cannot capture an image of the face of the occupant because the face of the occupant is hidden by the steering wheel.

Therefore, in this case, in the occupant detection device 1, the image capturing unit 10 can capture an image of the face of the occupant with higher accuracy when attached to the display unit 20 from a direction other than the right side face side of the display unit 20 than when attached to the display unit 20 from the right side face side of the display unit 20.

Conversely, in a case where the vehicle 100 is a left-hand drive vehicle, in the occupant detection device 1, the image capturing unit 10 can capture an image of the face of the occupant with higher accuracy when attached to the display unit 20 from a direction other than the left side face side of the display unit 20 than when attached to the display unit 20 from the left side face side of the display unit 20.

Further, for example, in a case where a control panel of an air conditioner or the like is provided below the display unit 20, the occupant may extend a hand to operate the control panel. Then, the face of the occupant may be hidden by the hand of the occupant operating the control panel. Therefore, in this case, in the occupant detection device 1, the image capturing unit 10 can capture an image of the face of the occupant with higher accuracy when attached to the display unit 20 from a direction other than the bottom face side of the display unit 20 than when attached to the display unit 20 from the bottom face side of the display unit 20.

Further, in the first embodiment, the image capturing unit 10 includes one illumination unit 12 (see FIG. 2), but this is merely an example. The image capturing unit 10 may include, for example, a plurality of illumination units 12. In addition, for example, the illumination unit 12 may be provided outside the image capturing unit 10. In addition, since the illumination unit 12 is for ensuring imaging luminance when the image capturing unit 10 captures an image of the occupant, it is preferable that the disposing position of the illumination unit 12 and the disposing position of the image capturing unit 10 are not largely separated from each other. If the disposing position of the illumination unit 12 and the disposing position of the image capturing unit 10 are far away from each other, for example, a shadow is generated on an occupant who is an imaging target of the image capturing unit 10, and the accuracy of the captured image is deteriorated. Therefore, the illumination unit 12 and the image capturing unit 10 need to be installed so as not to be largely separated. In the occupant detection device 1 according to the first embodiment, since the image capturing unit 10 includes the illumination unit 12, the illumination unit 12 and the image capturing unit 10 are provided without being significantly separated from each other, and the image capturing unit 10 can accurately capture an image of the occupant appropriately irradiated with light by the illumination unit 12. In addition, in the occupant detection device 1 according to the first embodiment, since the image capturing unit 10 includes the illumination unit 12, devices necessary for imaging of the occupant can be integrated in the image capturing unit 10 and downsized.

Further, in the first embodiment described above, in a state where the occupant detection device 1 is mounted on the vehicle 100, the image capturing unit 10 captures an image of an area in which the face of the occupant is to be present in the vehicle 100, but this is merely an example.

The image capturing unit 10 may capture an image of an area where not only the face but also the head or the body of the occupant in the vehicle 100 is to be present. In this case, for example, on the basis of the captured image captured by the image capturing unit 10, the occupant detection device 1 can detect the posture or the head position of the occupant, detect whether or not the driver is in a state of taking a posture suitable for driving, or detect a sudden change in physical condition of the occupant.

In the first embodiment, in a state where the occupant detection device 1 is mounted on the vehicle 100, the image capturing unit 10 is only required to be able to image an area where at least the face of the occupant is to be present in the vehicle 100.

As described above, the occupant detection device 1 according to the first embodiment is mounted on the vehicle 100 and includes the display unit 20 provided in the vehicle 100, and the image capturing unit 10 detachably attached to the display unit 20 to capture an image of an area in which at least the face of the occupant is to be present in the vehicle 100. Thus, in the occupant detection device 1, the image capturing unit 10 (image capturing device) can be provided at a preferable position as a disposing position without requiring a space for disposing the display unit 20 (display device) and a space for disposing the image capturing unit 10 (image capturing device) in the vehicle 100.

Further, since the image capturing unit 10 is detachably attached to the display unit 20, a manufacturer or the like can design or manufacture the image capturing unit 10 in accordance with the specifications of the vehicle 100, and provide the occupant detection device 1 in which the image capturing unit 10 is freely combined with the common display unit 20. Since the display unit 20 can be shared regardless of the specifications of the vehicle 100, the manufacturer or the like can suppress labor or the like required for designing or manufacturing the occupant detection device 1.

Further, in the occupant detection device 1 according to the first embodiment, the image capturing unit 10 is configured to have an angle of view in accordance with the specifications of the vehicle 100 in which the image capturing unit 10 is provided. Thus, the manufacturer or the like can design or manufacture the image capturing unit 10 in accordance with the specifications of the vehicle 100, and can provide the occupant detection device 1 in which the image capturing unit 10 is freely combined with the common display unit 20. Since the display unit 20 can be shared regardless of the specifications of the vehicle 100, the manufacturer or the like can suppress labor or the like required for designing or manufacturing the occupant detection device 1.

Further, in the occupant detection device 1 according to the first embodiment, as the direction of the optical axis of the image capturing unit 10, it is configured to have a direction in accordance with the specifications of the vehicle 100 in which the image capturing unit 10 is provided. Thus, the manufacturer or the like can design or manufacture the image capturing unit 10 in accordance with the specifications of the vehicle 100, and can provide the occupant detection device 1 in which the image capturing unit 10 is freely combined with the common display unit 20. Since the display unit 20 can be shared regardless of the specifications of the vehicle 100, the manufacturer or the like can suppress labor or the like required for designing or manufacturing the occupant detection device 1.

Further, in the occupant detection device 1 according to the first embodiment, the image capturing unit 10 is configured to include the illumination unit 12 for illuminating the inside of the vehicle 100 in which the image capturing unit 10 is provided. Thus, in the occupant detection device 1, devices necessary for imaging of the occupant can be integrated in the image capturing unit 10 and can be downsized.

Further, in the occupant detection device 1 according to the first embodiment, the front face of the image capturing unit 10 is covered with the first panel, the front face of the display unit 20 is covered with the second panel, and the first panel and the second panel are made of the same material. Thus, the occupant detection device 1 can create the unity of appearance between the image capturing unit 10 and the display unit 20.

Further, in the occupant detection device 1 according to the first embodiment, in a state where the image capturing unit 10 is attached to the display unit 20, a distance between one side of the image capturing unit 10 on a side attached to the display unit 20 and one side of the display unit 20 on a side to which the image capturing unit 10 is attached is equal to or less than a set distance. Thus, the occupant detection device 1 can create the unity of appearance between the image capturing unit 10 and the display unit 20.

Further, in the occupant detection device 1 according to the first embodiment, the image capturing unit 10 is configured to have a display area on the front face.

Thus, the occupant detection device 1 can cause the occupant to recognize indispensable display.

Further, the occupant detection device 1 according to the first embodiment is configured to include a frame that covers the entire side faces of the display unit 20 and the image capturing unit 10 in a state where the image capturing unit 10 is attached to the display unit 20. This enables the occupant detection device 1 to make the connected image capturing unit 10 and display unit 20 appear thinner to the occupant or the like.

Further, in the occupant detection device 1 according to the first embodiment, the image capturing unit 10 is attached to the display unit 20 from the top face side of the display unit 20, the left side face side of the display unit 20, the right side face side of the display unit 20, or the bottom face side of the display unit 20. Thus, in the occupant detection device 1, the position of the image capturing unit 10 with respect to the display unit 20 can be set to a position at which an optimum captured image can be obtained in accordance with the specifications of the vehicle 100 on which the occupant detection device 1 is mounted.

Note that, in the present disclosure, any component of the embodiment can be modified, or any component of the embodiment can be omitted.

### INDUSTRIAL APPLICABILITY

In the occupant detection device according to the present disclosure, the image capturing device can be provided at a preferable position as a disposing position without requiring a space for disposing the display device and a space for disposing the image capturing device in the vehicle.

### REFERENCE SIGNS LIST

100: vehicle, 1: occupant detection device, 10, 10a, 10b: image capturing unit, 20: display unit, 11, 11a, 11b: camera lens, 12, 12a, 12b: illumination unit, 3: instrument panel, 4: frame, 101a, 101b, 102a, 102b: display area

1.-12. (canceled)

13. An occupant detection device to be mounted on a vehicle, the occupant detection device comprising:
a display device to be provided in the vehicle; and
an image capturing device detachably attached to the display device to capture an image of an area in which at least a face of an occupant is to be present in the vehicle, wherein
a front face of the image capturing device is covered with a first panel,
a front face of the display device is covered with a second panel.

14. The occupant detection device according to claim 13, wherein
the first panel and the second panel are made of a same material.

15. The occupant detection device according to claim 13, wherein
the image capturing device has an angle of view in accordance with a specification of the vehicle in which the image capturing device is provided.

16. The occupant detection device according to claim 13, wherein
a direction of an optical axis of the image capturing device is a direction in accordance with a specification of the vehicle in which the image capturing device is provided.

17. The occupant detection device according to claim 15, wherein
the specification of the vehicle includes a vehicle type, a grade of the vehicle, or an orientation of the display device in a state where the display device is provided in the vehicle.

18. The occupant detection device according to claim 13, wherein
the image capturing device includes an illumination device for illuminating an inside of the vehicle in which the image capturing device is provided.

19. The occupant detection device according to claim 13, wherein
in a state where the image capturing device is attached to the display device, a distance between a side of the image capturing device on a side where the image capturing device is attached to the display device and a side of the display device on a side where the display device is attached to the image capturing device is equal to or less than a set distance.

20. The occupant detection device according to claim 13, wherein
the image capturing device has a display area on a front face.

21. The occupant detection device according to claim 20, wherein
notification information for alerting the occupant is displayed in the display area.

22. The occupant detection device according to claim 13, further comprising:
a frame to cover an entire side faces of a combination of the display device and the image capturing device in a state where the image capturing device is attached to the display device.

23. The occupant detection device according to claim 13, wherein
the image capturing device is attached to the display device from a top face side of the display device, a left side face side of the display device, a right side face side of the display device, or a bottom face side of the display device.

24. An image capturing device that captures an image of an area in which at least a face of an occupant is to be present in a vehicle provided with a display device, wherein
the image capturing device is detachably connected to the display device, wherein
a front face of the image capturing device is covered with a first panel,
a front face of the display device is covered with a second panel.
